(19) United States
(12) Patent Application Publication
(10) Pub. No.: US 2010/0271922 A1
(43) Pub. Date: Oct. 28, 2010

(54) HOLOGRAM RECORDING DEVICE

(75) Inventors: Yasumasa Iwamura, Kawasaki (JP); Koichi Tezuka, Kawasaki (JP); Hiroyasu Yoshikawa, Kawasaki (JP); Kazushi Uno, Kawasaki (JP); Yuzuru Yamakage, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/769,216

(22) Filed: Apr. 28, 2010

Related U.S. Application Data
(63) Continuation of application No. PCT/JP2007/071231, filed on Oct. 31, 2007.

(51) Int. Cl. G11B 7/00

(52) U.S. Cl. 369/103; G9B/7

(57) ABSTRACT

A hologram recording device that records a hologram by passing recording light and reference light through the same objective lens and irradiating a recording medium, includes: a light splitter for dividing light from a light source into the recording light and the reference light; a light combining member for combining the recording light and the reference light, which have been divided by the light splitter, so as to be coaxial, and causing these light beams to advance to the objective lens; first and second lenses, positioned on an optical paths of the recording light and reference light, between the light splitter and the light combining member; a first aperture that narrows the recording light which has passed through the first lens; and, a second aperture that narrows the reference light which has passed through the second lens, the first and second lenses being configured to have different optical magnifications.

### CROSS-REFERENCE TO RELATED APPLICATION

This application is a continuation of International Application No. PCT/JP2007/071231, filed on Oct. 31, 2007, the entire contents of which are incorporated herein by reference.

### TECHNICAL FIELD

An embodiment of the present invention relates to a hologram recording device, which records holograms using the so-called coaxial method.

### BACKGROUND ART

A conventional hologram recording device is for example disclosed in Patent Reference 1. The hologram recording device disclosed in this document is configured so as to record holograms in a recording medium using a coaxial method. In such a hologram recording device, light from a light source is converted into a parallel beam by a collimating lens, after which a spatial optical modulator divides the light into recording light (signal light) and reference light, and the recording light and reference light pass through the same objective lens and are made incident on the hologram recording medium. In the spatial optical 1 modulator, the center portion of a pixel region includes a region which generates recording light, and the peripheral portion of the pixel region is a region which generates reference light. In a hologram recording device employing such a coaxial method, the optical path of recording light and the optical path of reference light always coincide.

On the other hand, as disclosed for example in Patent Reference 2, a hologram recording device employing a different method uses a beam splitter to divide light from a light source into recording light and reference light, and is configured such that these light beams again overlap in the recording medium. In a hologram recording device employing such a light division method, a Fourier transform lens, which suppresses the Fourier spectrum distribution, is placed in the optical path of the recording light. The Fourier spectrum is a distribution in which the light intensity is stronger for specific frequency components, and the optical intensity of the so-called DC component appears as a prominent bright spot. Such a Fourier spectrum is the basis for the occurrence of brightness unevenness when recording holograms, and so it is desirable that the Fourier spectrum distribution not only of the recording light, but also of the reference light be appropriately suppressed.

Patent Document 1: Japanese Laid-open Patent Publication No. 2006-113296

Patent Document 2: Japanese Laid-open Patent Publication No. 2006-78686

However, in the above-described coaxial-method hologram recording device of the prior art, the recording light and the reference light travel the same optical path, so that Fourier spectrum components for each of these cannot be suppressed separately and appropriately, and consequently there is the problem that a hologram cannot be satisfactorily recorded.

### DISCLOSURE OF THE INVENTION

Embodiments of the present invention have been proposed in light of the above-described circumstances. An object of this invention is to provide a coaxial-method hologram recording device, which individually and appropriately adjusts recording light and reference light, and which can satisfactorily record holograms.

In order to attain the above object, in this invention, the following technical means is devised.

A hologram recording device provided by an embodiment of the invention is a hologram recording device which records a hologram by passing recording light and reference light through the same objective lens and irradiating a recording medium. The hologram recording device includes: a light splitter for dividing light from a light source into the recording light and the reference light; a light combining member for combining the recording light and the reference light, which have been divided by the light splitter, so as to be coaxial, and causing these light beams to advance to the objective lens; a first lens, positioned on an optical path of the recording light, between the light splitter and the light combining member; a second lens, positioned on an optical path of the reference light, between the light splitter and the light combining member; a first aperture that narrows the recording light which has passed through the first lens; and a second aperture that narrows the reference light which has passed through the second lens, wherein the requirement that the first and second lenses are set so as to have different optical magnifications.

It is preferable that the optical magnification may be larger for the second lens than for the first lens.

It is preferable that the second aperture may be set so as to limit the Fourier spectrum distribution more than the first aperture.

It is preferable that a first spatial optical modulator that generates the recording light according to information to be recorded may be placed between the light splitter and the first lens, and that a second spatial optical modulator that imparts a prescribed phase pattern to the reference light be placed between the light splitter and the second lens.

It is preferable that a spatial optical modulator that generates the recording light according to the information to be recorded in a center portion of a pixel region, and generates the reference light having a prescribed phase pattern in a peripheral portion of the pixel region, may be placed between the light source and the light splitter.

It is preferable that the light splitter may include a first opening reflection member, having a center opening which directly passes the recording light from the spatial optical modulator to the first lens and a peripheral reflecting face, which, on a periphery outside the center opening, causes the reference light to be reflected so as to be directed toward the second lens.

It is preferable that the light combining member may include a second opening reflection member, having a center opening which directly passes the recording light which has passed through the first aperture to the objective lens, and a peripheral reflecting face, which, on a periphery outside the center opening, causes the reference light which has passed through the second aperture to be reflected in the same direction as the direction of advance of the recording light.

### BRIEF DESCRIPTION OF THE DRAWINGS

FIG. 1 illustrates the configuration of the hologram recording device of one embodiment of the invention;

FIG. 2 is a schematic diagram of the second spatial optical modulator included by the hologram recording device of FIG. 1;

FIG. 3 is an explanatory diagram to explain optical characteristics of the hologram recording device of FIG. 1;

FIG. 4 illustrates the configuration of the hologram recording device of another embodiment of the invention;

FIG. 5 illustrates the configuration of the hologram recording device of another embodiment of the invention; and

FIG. 6 is a schematic diagram of a spatial optical modulator of another embodiment of the invention.

### BEST MODE FOR CARRYING OUT THE INVENTION

Below, preferred embodiments of the invention will be described below with reference to the drawings.

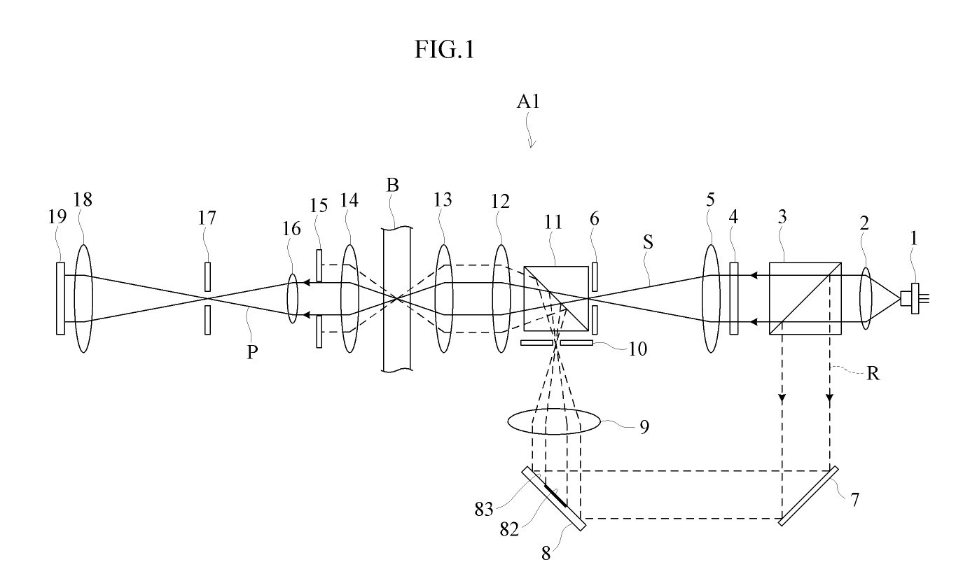

FIG. 1 through FIG. 3 illustrate an embodiment of a hologram recording device of the invention. As illustrated in FIG. 1, the hologram recording device A1 is configured so as to record holograms on the recording medium B using the so-called coaxial method. This hologram recording device A includes a light source 1; collimating lens 2; first beam splitter 3 as a light splitter; first spatial optical modulator 4; first lens 5; first aperture 6; fixed mirror 7; second spatial optical modulator 8; second lens 9; second aperture 10; second beam splitter 11 as light combining member; emission lens 12; recording objective lens 13; reproduction objective lens 14; optical filter 15; incidence lens 16; reproduction aperture 17; condensing lens 18; and image capture element 19.

Recording light S passes through the collimating lens 2 from the light source 1 and is incident on the first beam splitter 3, and passes through the first beam splitter 3. Then, the recording light S passes in order through the first spatial optical modulator 4, first lens 5, and first aperture 6, is incident on the second beam splitter 11, and after passing through this second beam splitter 11, passes through the emission lens 12 and objective lens 13 and irradiates the recording medium B. Reference light R passes through the collimating lens 2 from the light source 1, is incident on the first beam splitter 3, and is reflected by the first beam splitter 3 in a direction different from the recording light S. Thereafter, the reference light R passes in order through the fixed mirror 7, second spatial optical modulator 8, second lens 9, and second aperture 10, is incident on the second beam splitter 11, and is reflected by the second beam splitter 11 to advance in the same direction as the recording light S, and then travels on the same optical path as the recording light S by means of the emission lens 12 and objective lens 13 to irradiate the recording medium B.

The recording medium B has for example a photopolymer recording layer, and through interference of the recording light S and reference light R in this recording layer, a hologram is recorded. At the time of reproduction, the recording layer is irradiated with reference light R, and diffracted light is generated as reproduction light P according to the recorded hologram; by receiving this reproduction light P using the image capture element 6, information recorded as the hologram is extracted.

The light source 1 includes for example a semiconductor laser element. This light source 1 emits coherent laser light in a comparatively narrow band during recording and reproduction.

The collimating lens 2 converts laser light emitted from the light source 1 into a parallel light beam. Laser light which has become a parallel light beam is incident on the first beam splitter 3.

The first beam splitter 3 includes for example a Wollaston prism polarizing beam splitter, and divides incident laser light into recording light S and reference light R with a prescribed luminous flux ratio.

The first spatial optical modulator 4 includes for example a transmissive liquid crystal panel, and has a pixel region which is subjected to on/off control for each pixel. In this pixel region, a pixel pattern is formed according to the information to be recorded, and the recording light S is optically modulated by this pixel pattern. During reproduction, the recording medium B is irradiated with reference light R only, so that all the pixels are in the off state, and recording light S is blocked.

The first lens 5 forms a relay lens paired with the emission lens 12, which guides the recording light S to the emission lens 12 while reducing the ray diameter of the recording light S. If the focal length of the first lens 5 is fs and the focal length of the emission lens 12 is fo, then the optical magnification of the relay lens with the first lens 5 is fo/fs.

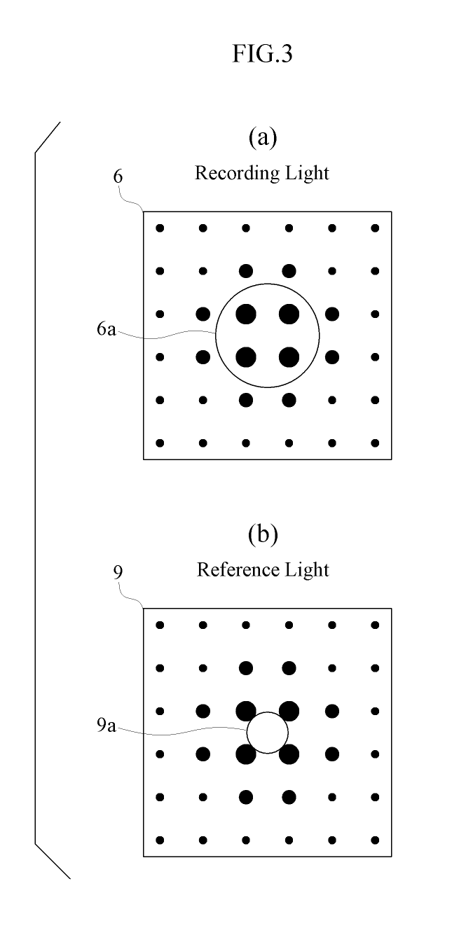

The first aperture 6 is placed in the focal plane of the first lens 5 between the first lens 5 and the emission lens 12, on the incident plane side of the second beam splitter 11, and imparts spatial changes to the optical image formed by the first lens 5. Specifically, as illustrated in (a) of FIG. 3, a Fourier spectrum image, including a plurality of bright spots (portions illustrated as round dark spots in the figure), appears in the focal plane of the first lens 5 in which the first aperture 6 is placed. In this Fourier spectrum image, the optical intensity of the DC component is prominently emphasized as a specific frequency component, and portions which are emphasized appear as bright spots. As illustrated in the figure, the first aperture 6 has an opening 6a so as to include the brightest DC component bright spots, and by means of this opening 6a, the recording light S is narrowed.

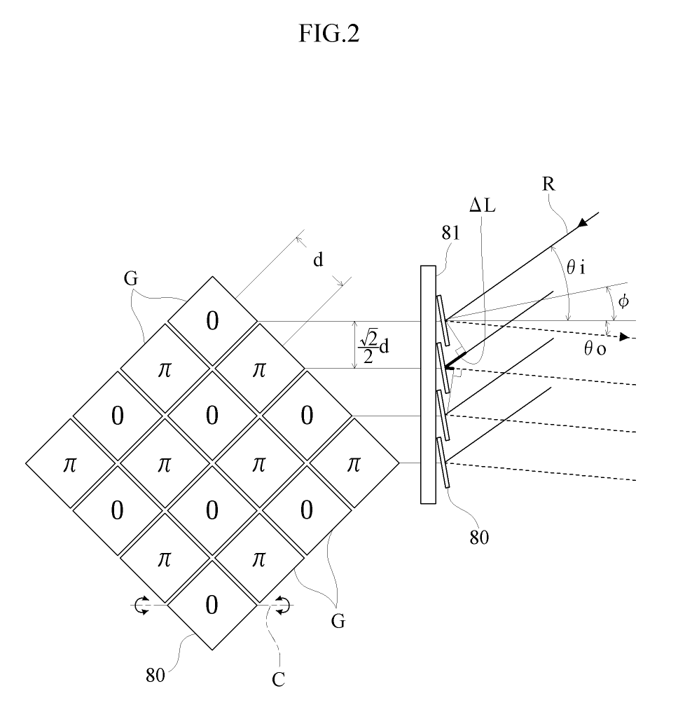

The second spatial optical modulator 8 is provided as a phase modulator to impart a prescribed phase pattern to the reference light R, and includes for example, as illustrated in FIG. 2, a deformable mirror device, capable of selecting the direction of reflection of light for each pixel G. Each pixel G includes a movable reflecting element 80 which is driven in rotation about a shaft along a diagonal line. In the case of the on state when the reference light R from the fixed mirror 7 advances toward the second lens 9, as illustrated in the figure, the movable reflecting elements 80 form a prescribed inclination angle φ with the reference plane 81. On the other hand, in the case of the off state when the reference light R is not advancing toward the second lens 9, the movable reflecting elements 80 have an attitude (not illustrated) which is inverted from the attitude illustrated in FIG. 2. In this embodiment, as illustrated in FIG. 1, light incident on the center portion 82 of the pixel region is removed, and light incident on the peripheral portion 83 of the pixel region is guided to the second lens 9.

Specifically, as illustrated in FIG. 2, if the inclination angle of the movable reflection element 80 is φ, the interval with adjacent pixels G (the pixel pitch) is d, the incidence angle and emission angle of reference light R on the reference plane 81 are θi and θo, and the wavelength of the reference light R is λ, then the optical path difference ΔL with adjacent pixels G satisfies the following equation 1 so that there is a phase difference π with the adjacent pixels G.

$$Δ L = \frac{\sqrt{2}}{2} d \cdot ( sin θ i + sin θ o ) = ( m + \frac{1}{2} ) λ \\ ( m \text{:} integer ) \qquad Equation 1$$

With respect to the incidence angle θi, emission angle θo, and inclination angle φ, the relation θi+θo=2φ is satisfied. Based on this equation and equation 1 above, when the wavelength λ is 405 nm and the inclination angle φ is 12°, the pixel pitch d is 13.7 μm.

In such a second spatial optical modulator 8, pixels G are formed which have a phase shift of π from 0-phase at the peripheral portion 83 of the pixel region and the pixel G. By performing on/off control of these 0-phase pixels G and π-phase pixels G, various phase patterns with phase 0 and phase π are imparted to the reference light R. That is, the hologram recording device A1 of this embodiment performs multiplex recording of holographs by a so-called phase-shift method.

The second lens 9 forms a relay lens paired with the emission lens 12, which guides the reference light R to the emission lens 12 while enlarging the ray diameter of the reference light R. If the focal length of the second lens 9 is fr, and the focal length of the emission lens 12 is fo, then the optical magnification of the relay lens with the second lens 9 is fo/fr. The relay lens with the first lens 5 described above is a reducing system lens with optical magnification fo/fs. From this, fo/fs>fo/fr. That is, the second lens 9 has a larger optical magnification than the first lens 5.

The second aperture 10 is placed between the second lens 9 and the emission lens 12, in the focal plane of the second lens 9 on the side of the incidence plane of the second beam splitter 11, and imparts spatial changes to the optical image formed by the second lens 9. Specifically, as illustrated in (b) of FIG. 3, a Fourier spectrum image appears, with a plurality of bright spots (portions illustrated as round dark spots in the figure), in the focal plane of the second lens 9 in which the second aperture 10 is placed. As illustrated in the figure, the second aperture 9 has an opening 9a which passes almost none of the bright spots of the largest DC component, and is configured so that by means of this opening 9a the reference light R is narrowed. By means of such a second aperture 10, the Fourier spectrum is limited more than by the first aperture 6.

The second beam splitter 11 includes for example a Wollaston prism polarizing beam splitter. In this second beam splitter 11, recording light S is passed straight toward the emission lens 12, whereas reference light R is reflected to the same direction as the direction of advance of this recording light S. By this means, recording light S and reference light R are incident, in a coaxially combined state, on the emission lens 12.

The recording objective lens 13 condenses the recording light S and reference light R which have passed through the emission lens 12 in the recording layer of the recording medium B.

The reproduction objective lens 14 has essentially the same optical characteristics as the recording objective lens 13, and guides the reproduction light P generated during reproduction to the image capture element 19.

The optical filter 15 removes noise due to the reference light R from the reproduction light P, and guides only reproduction light P contributing to reproduction to the incidence lens 16.

The incidence lens 16 and reproduction aperture 17 have essentially the same optical characteristics as the emission lens 12 and first aperture 6, and are placed so as to be in an optically conjugate relation with these optical components.

The condensing lens 18 condenses reproduction light P, which has been narrowed by the reproduction aperture 17, on the image capture element 19.

The image capture element 19 receives reproduction light P and outputs the image of this reproduction light P as a hologram image. The hologram image is further input to an optical demodulation circuit (not illustrated) or similar. By this means, information recorded as a hologram in the recording medium B is reproduced.

Next, optical action of the hologram recording device A1 is explained.

During recording, laser light from the light source 1 passes through the collimating lens 2 and is divided into recording light S and reference light R by the first beam splitter 3.

Recording light S is modulated by the first spatial optical modulator 4, and then passes through the first lens 5 and first aperture 6, and is incident on the second beam splitter 11. At this time, as illustrated in (a) of FIG. 3, a Fourier spectrum image appears in the focal plane of the first lens 5 in which the first aperture 6 is placed. This Fourier spectrum of the recording light S occurs as the result of a Fourier transform of a pixel pattern based on the information to be recorded, and so bright spots are passed to a certain degree, and the recording light S is made to advance so that there is no optical loss of information.

On the other hand, reference light R is phase-modulated by the second spatial optical modulator 8, and then passes through the second lens 9 and second aperture 10 and is incident on the second beam splitter 11. At this time, as illustrated in (b) of FIG. 3, a Fourier spectrum image also appears in the focal plane of the second lens 9 in which the second aperture 10 is placed. This Fourier spectrum of the reference light R occurs as a result of a Fourier transform of the phase pattern due to phase modulation. In order to perform satisfactory hologram recording, it is desirable that the reference light R have a uniform intensity overlapping that of the recording light S. For this reason, the reference light R is made to advance with its ray diameter enlarged by the second lens 9, and narrowed to an extent that that bright spots are not passed by the second aperture 10.

Recording light S and reference light R are combined so as to become a single ray by the second beam splitter 11, and pass through the emission lens 12 and objective lens 13 to irradiate the recording medium B. By this means, a hologram is recorded in the portion irradiated with the recording light S and reference light R in an overlapping state. At this time, DC component noise due to the Fourier spectrum is removed from the reference light R, so that the hologram is recorded in a satisfactory state.

Hence by means of the hologram recording device A1 of this embodiment, recording light S and reference light R can be adjusted individually and appropriately, and in particular noise due to the Fourier spectrum can be efficiently removed from the reference light R, so that a hologram can be satisfactorily recorded in the recording medium B.

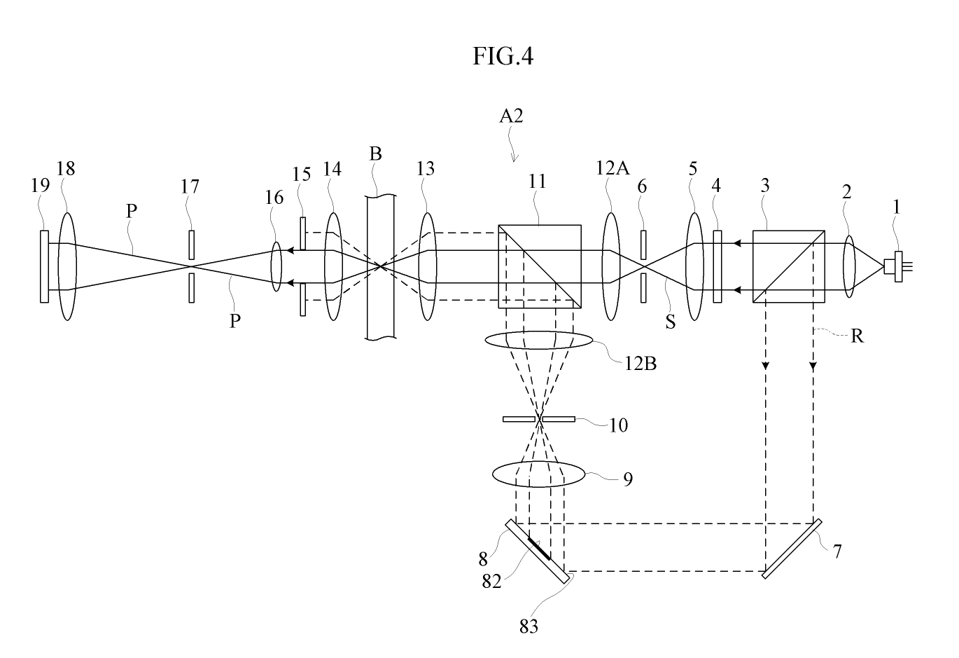

FIG. 4 through FIG. 6 illustrate the configuration of another embodiment. Constituent elements which are the same as or similar to those in the above-described embodiments are assigned the same symbols, and explanations are omitted.

In the hologram recording device A2 illustrated in FIG. 4, an emission lens 12A paired with the first lens 5 and an emission lens 12B paired with the second lens 9 are provided. The one emission lens 12A is placed in the optical path of the recording light S between the first aperture 6 and the second beam splitter 11, and the other emission lens 12B is placed in the optical path of the reference light R between the second aperture 10 and the second beam splitter 11.

By means of this configuration, the recording light S and reference light R can be adjusted more appropriately prior to incidence on the second beam splitter 11, so that a hologram can be recorded extremely satisfactorily in the recording medium B.

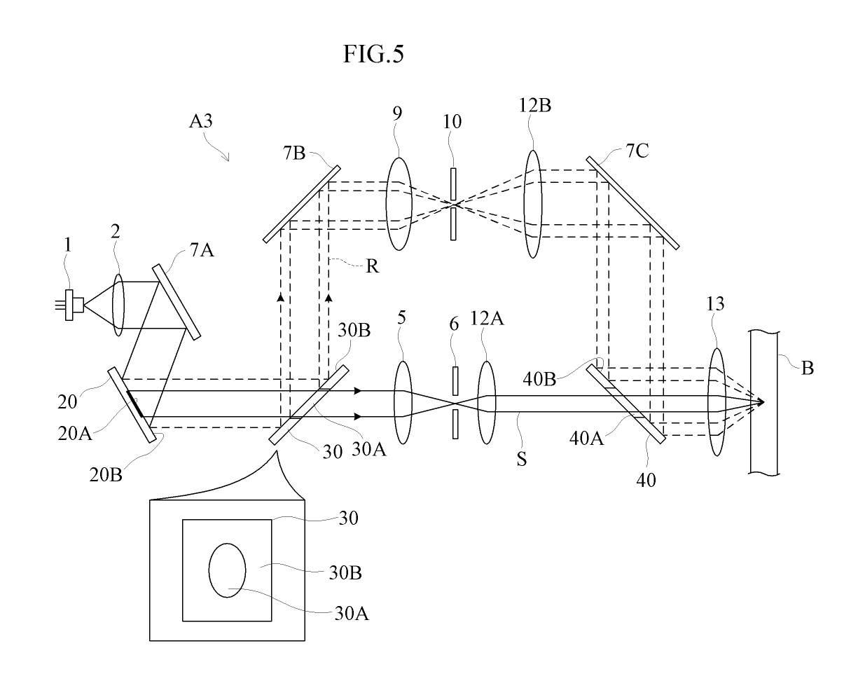

The hologram recording device A3 of FIG. 5 includes constituent elements similar to those of the above-described embodiment, and in addition includes fixed mirrors 7A to 7C, one spatial optical modulator 20, a first opening reflection member 30 as optical dividing member, and a second opening reflection member 40 as light combining member. The spatial optical modulator 20 includes a deformable mirror device similar to the above-described second spatial optical modulator 8; the center portion 20A of the pixel region is the region which generates recording light S, and the peripheral portion 20B of the pixel region is the region which generates reference light R by means of phase modulation. The first opening reflection member 30 has a center opening 30A which directly passes recording light S to the first lens 5, and a peripheral reflecting face 30B which, on the periphery outside the center opening 30A, reflects reference light R and directs the light toward the second lens 9. The second opening reflection member 40 is configured similarly to the above-described first opening reflection member 30, and has a center opening 40A which directly passes recording light S to the objective lens 13, and, on the periphery outside the center opening 40A, a peripheral reflecting face 40B which reflects reference light R and directs the light in the same direction as the direction of advance of recording light S. In the figure, optical components to receive reproduction light, such as image capture elements and similar, are omitted.

Laser light from the light source 1 passes through the collimating lens 2 and fixed mirror 7A and enters the spatial optical modulator 20, and light modulated by the center portion 20A of the spatial optical modulator 20 becomes recording light S. Recording light S passes through the center opening 30A of the opening reflection member 30, passes in order through the first lens 5, first aperture 6, and emission lens 12A, passes through the center opening 40A of the opening reflection member 40, and irradiates the recording medium B by means of the objective lens 13. On the other hand, light which has been phase-modulated by the peripheral portion 20B of the spatial optical modulator 20 becomes reference light R; this reference light R is reflected by the peripheral reflection face 30B of the opening reflection member 30, and so is separated from the recording light S. Then, the reference light R passes in order through the fixed mirror 7B, second lens 9, second aperture 10, emission lens 12B, and fixed mirror 7C, is again reflected by the peripheral reflecting face 40B of the opening reflection member 40, and is again combined with the recording light S in a coaxial state. By this means the reference light R is combined with the recording light S and, passing through the objective lens 13, irradiates the recording medium B.

By means of this configuration, laser light can be divided into recording light S and reference light R, and moreover can again be combined, without using expensive optical components such as beam splitters, so that an inexpensive device can be configured. Further, the spatial optical modulator 20 can modulate the recording light S and the reference light R together, so that there is no need to provide two spatial optical modulators as in the above-described embodiments, and by this means also an inexpensive device can be configured, and the number of components can be reduced.

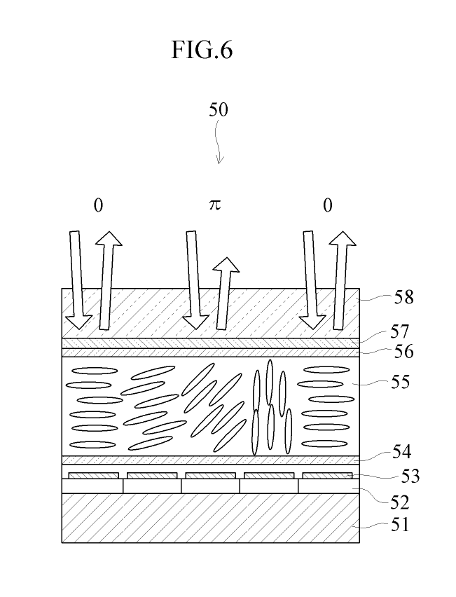

FIG. 6 illustrates a spatial optical modulator 50 configured as a reflective-type liquid crystal panel, as another embodiment. This spatial optical modulator 50 is configured having a silicon substrate 51, liquid crystal driving circuit 52, pixel electrodes 53, orientation film on the lower-face side 54, liquid crystal layer 55 in which for example ferroelectric liquid crystals are filled, orientation film on the upper-face side 56, transparent electrode 57, and transparent substrate 58. By means of a spatial optical modulator 50 configured as a reflective liquid crystal panel in this way, the phase of input light can be changed for each pixel by driving the liquid crystals, and use as a phase modulator is possible.

This invention is not limited to the above embodiments.

Instead of multiplex recording of a hologram using a phase-shift method, in a case of a configuration in which a hologram is recorded with a single interference fringe pattern for each portion irradiated by recording light and reference light, interference with the recording light may be caused without phase modulation of the reference light.

As the second spatial optical modulator which phase-modulates the reference light, phase modulation of the entire pixel region may be performed, without discriminating between the pixel region center portion and the peripheral portion.

1. A hologram recording device which records a hologram by passing recording light and reference light through the same objective lens and irradiating a recording medium, the hologram recording device comprising:
a light splitter for dividing light from a light source into the recording light and the reference light;
a light combining member for combining the recording light and the reference light, divided by the light splitter, so as to be coaxial, and causing these light beams to advance to the objective lens;
a first lens, positioned on an optical path of the recording light, between the light splitter and the light combining member;
a second lens, positioned on an optical path of the reference light, between the light splitter and the light combining member;
a first aperture that narrows the recording light which has passed through the first lens; and,
a second aperture that narrows the reference light which has passed through the second lens, wherein
the first and second lenses are set so as to have different optical magnifications.

2. The hologram recording device according to claim 1, wherein the optical magnification is larger for the second lens than for the first lens.

3. The hologram recording device according to claim 1, wherein the second aperture is set so as to limit the Fourier spectrum distribution more than the first aperture.

4. The hologram recording device according to claim 1, wherein a first spatial optical modulator that generates the recording light according to information to be recorded is placed between the light splitter and the first lens, and a second spatial optical modulator that imparts a prescribed phase pattern to the reference light is placed between the light splitter and the second lens.

5. The hologram recording device according to claim 1, wherein a spatial optical modulator that generates the recording light according to the information to be recorded in a center portion of a pixel region, and that generates the reference light having a prescribed phase pattern in a peripheral portion of the pixel region is placed between the light source and the light splitter.

6. The hologram recording device according to claim 5, wherein the light splitter includes a first opening reflection member, having a center opening which directly passes the recording light from the spatial optical modulator to the first lens, and a peripheral reflecting face, which, on a periphery outside the center opening, causes the reference light to be reflected so as to be directed toward the second lens.

7. The hologram recording device according to claim 6, wherein the light combining member includes a second opening reflection member, having a center opening which directly passes the recording light which has passed through the first aperture to the objective lens, and a peripheral reflecting face, which, on a periphery outside the center opening, causes the reference light which has passed through the second aperture to be reflected in the same direction as the direction of advance of the recording light.
